(19) United States
(12) Patent Application Publication
(10) Pub. No.: US 2019/0344761 A1
(43) Pub. Date: Nov. 14, 2019

(54) DRUM-INTEGRATED TYPE PARKING BRAKE

(71) Applicant: MANDO CORPORATION, Gyeonggi-do (KR)

(72) Inventor: Joon Geun CHO, Gyeonggi-do (KR)

(21) Appl. No.: 16/401,034

(22) Filed: May 1, 2019

(30) Foreign Application Priority Data
May 8, 2018 (KR) 10-2018-0052401

(51) Int. Cl. B60T 1/06; F16D 51/22; F16D 65/66; F16D 66/00; B60T 17/22

(52) U.S. Cl. CPC B60T 1/067; F16D 51/22; F16D 2125/40; F16D 66/00; B60T 17/221; F16D 65/66

(57) ABSTRACT

The present invention relates to a drum-integrated type parking brake, the drum-integrated type parking brake according to one embodiment of the present invention may include a motor disposed on a rear surface of a back plate and having a driving shaft passing through the back plate and extending to a front surface of the back plate, an adjuster configured to convert a rotational force of the driving shaft into a linear reciprocating motion to linearly move a first rod and a second rod in directions, which are opposite to each other, and a leading shoe and a trailing shoe coupled to the first rod and the second rod of the adjuster, respectively, to press against or be spaced away from a drum.

### CROSS-REFERENCE TO RELATED APPLICATION

This application claims priority to and the benefit of Korean Patent Application No. 2018-0052401, filed on May 8, 2018, the disclosure of which is incorporated herein by reference in its entirety.

### BACKGROUND

### 1. Field of the Invention

The present invention relates to a drum-integrated type parking brake, and more particularly, to a drum-integrated type parking brake in which a structure of an adjuster is modified to allow a shoe gap adjustment and parking operation to be performed.

### 2. Discussion of Related Art

Generally, a drum brake is configured to push a brake shoe (lining) outward and come into contact with an inner surface of a brake drum which is being rotated so as to brake the brake drum. In a parking brake which is integrally formed with the drum brake, a parking cable connected to a brake lever is pulled and activates the brake shoe to prevent a wheel from being rotated in a parking state.

A drum-integrated type manual parking brake is described in detail in Korean Patent No. 10-0398257 (entitled “Drum Brake for Vehicle” and registered on Sep. 2, 2003). In the manual drum-integrated type parking brake, a parking cable is pulled according to manual operation of a parking lever, an actuation lever is operated by a tensile force of the parking cable to supply a hydraulic pressure, and thus a leading shoe and a trailing shoe are pressurized against a brake drum to prevent a wheel from being rotated.

In addition, Korean Patent No. 10-1305120 (entitled “Drum-Integrated Type Electronic Parking Brake” and registered on Sep. 2, 2013) discloses a parking brake including a motorized actuator configured to pull a parking rod. In this parking brake, when the parking rod is pulled, a leading shoe and a trailing shoe are pushed outward to allow a lining to come into contact with and press a drum, and thus a parking brake is operated.

However, the conventional drum-integrated type electronic parking brake employs the parking rod to operate both shoes and includes the motorized actuator and the cable (or a connecting shaft) for pulling the parking rod. Therefore, because of the relatively large number of components, an assembly process is relatively complicated and maintenance is not easy.

Further, there is a problem that since the motorized actuator is configured to be coupled to an outside of a side surface of a back plate, a large mounting space for the drum brake is required. In particular, there has been a problem that interference may occur between the motorized actuator and other peripheral part and since the motorized actuator is exposed to the outside, the actuator may be damaged by foreign matter while a vehicle is traveling.

### SUMMARY OF THE INVENTION

It is an object of the present invention to provide a drum-integrated type parking brake in which the number of components is reduced.

Another object of the present invention is to provide a drum-integrated type parking brake capable of performing a function of a parking brake together with a function of decelerating and stopping a vehicle while not substantially increasing an area of a drum brake.

More specifically, an object of the present invention is to provide a drum-integrated type parking brake capable of directly pushing a shoe outward without employing a parking rod to perform a function of a parking brake and capable of simultaneously performing a gap adjustment and a function of a parking brake by modifying a structure of an adjuster provided for a shoe gap adjustment.

According to one aspect of the present invention, there is provided a drum-integrated type parking brake including a motor disposed on a rear surface of a back plate and having a driving shaft passing through the back plate and extending to a front surface of the back plate, an adjuster configured to convert a rotational force of the driving shaft into a linear reciprocating motion to linearly move a first rod and a second rod in directions which are opposite to each other, and a leading shoe and a trailing shoe coupled to the first rod and the second rod of the adjuster, respectively, to press against or be spaced away from drums.

The adjuster may be configured to linearly move the first rod and the second rod in a direction perpendicular to the driving shaft and in directions in which the rods move away from each other or in directions in which the rods approach each other.

Furthermore, the adjuster may include a driving bevel gear coupled to the driving shaft, a pair of driven bevel gears meshing with the driving bevel gear, and a pair of driven shafts each coupled to one of the pair of driven bevel gears.

Each of the pair of driven shafts may have a thread formed on an outer surface thereof, the adjuster may further include a pair of nut parts coupled to each of the driven shafts to convert a rotation of the driven shafts into a rectilinear motion, and each of the first rod and the second rod may be positioned at one end of the nut parts.

The pair of driven shafts may be nut-type driven shafts, the adjuster may further include a pair of bolt parts each coupled to one of the nut-type driven shafts to convert a rotation of the nut-type driven shafts into a rectilinear motion, and each of the first rod and the second rod may be positioned at one end of the bolt parts.

The drum-integrated type parking brake may further include a sensor provided to detect a gap between the drum and each of the leading shoe and the trailing shoe and to detect an adjusted position or the rotation number of the motor so that, after the motor is driven to adjust positions of the leading shoe and the trailing shoe to adjust the gap, the adjusted positions are set to initial values.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is an exploded perspective view of a drum-integrated type parking brake according to one embodiment of the present invention;

FIG. 2 is a perspective view illustrating a partial configuration of an adjuster of the drum-integrated type parking brake according to one embodiment of the present invention;

FIG. 3 is a cross-sectional view of the adjuster of the drum-integrated type parking brake according to one embodiment of the present invention; and

FIG. 4 is a cross-sectional view of an adjuster of a drum-integrated type parking brake according to another embodiment of the present invention.

### DETAILED DESCRIPTION OF EXEMPLARY EMBODIMENTS

Hereinafter, a drum-integrated type parking brake of the present invention will be described in detail with reference to the accompanying drawings.

Embodiments of the present invention are provided to describe the present invention more fully to those skilled in the art, the embodiments described below can be modified into various other forms, and the scope of the present invention is not limited to the following embodiments. Rather, these embodiments make the invention more meaningful and complete and are provided for fully conveying the concept of the invention to those skilled in the art.

The terminologies used herein are for the purpose of describing particular embodiments only and are not intended to be limiting to the disclosure. As used herein, the singular forms are intended to include the plural forms as well, unless the context clearly indicates otherwise. In addition, the terms “comprises” and/or “comprising,” when used in this specification, specify the presence of stated features, integers, steps, operations, members, components and/or a group thereof but do not preclude the presence or addition of one or more other features, integers, steps, operations, components, and/or groups thereof. As used herein, the term “and/or” includes any one of and all combinations of one or more of the relevant listed items.

Although the terms “first,” “second,” etc. are used herein to describe various components, regions and/or parts, it is apparent that these members, components, regions, layers and/or part are not limited by these terms. These terms do not imply any particular order, top, bottom, or superiority and are used only to distinguish one member, region, or part from another member, region, or part. Thus, the first member, the first region, or the first part described below may refer to the second member, the second region, or the second part without departing from the teachings of the present invention.

Hereinafter, the embodiments of the present invention are described with reference to the drawings schematically illustrating the embodiments of the present invention. In the drawings, for example, variations in the illustrated shape may be expected depending on manufacturing techniques and/or tolerances. Accordingly, the embodiments of the present invention should not be construed as being limited to any particular shape of the regions illustrated herein and should include, for example, variations in shape resulting from manufacturing.

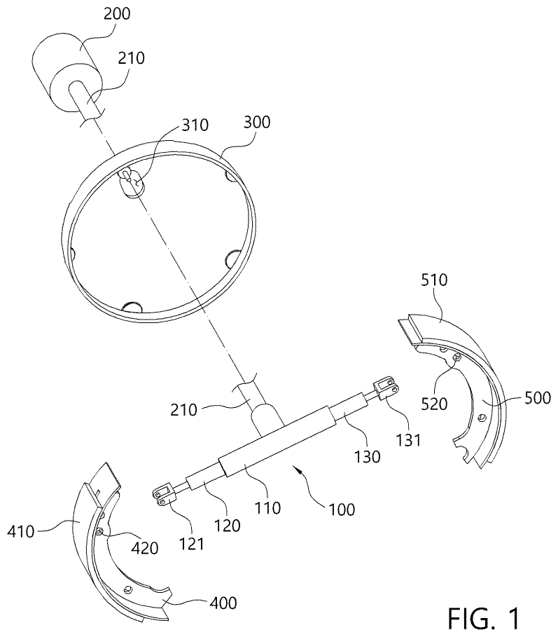

FIG. 1 is an exploded perspective view of a drum-integrated type parking brake according to one embodiment of the present invention. FIG. 1 illustrates a parking brake in which some structural components of a conventional drum brake are omitted. That is, a wheel cylinder for operating the drum brake, a spring such as a shoe return spring, an adjusting spring and the like, and a washer for coupling elements are omitted in FIG. 1.

Referring to FIG. 1, the drum-integrated type parking brake according to one embodiment of the present invention includes a back plate 300 of a drum brake, a motor 200 located on a rear surface of the back plate 300 and having a driving shaft 210 which passes through the back plate 300 and extends to a front surface of the back plate, an adjuster 100 coupled to the driving shaft 210 of the motor 200 to drive a first rod 121 and a second rod 131 in directions, which are opposite to each other, according to rotations of the driving shaft 210, and a leading shoe 400 and a trailing shoe 500 coupled to the first rod 121 and the second rod 131 of the adjuster 100, respectively.

Hereinafter, the drum-integrated type parking brake according to one embodiment of the present invention constructed as above will be described in detail.

First, the back plate 300 provides a space in which components of the drum brake other than a drum can be disposed. The back plate 300 secures an operating space in which the leading shoe 400 and the trailing shoe 500 are expanded and returned by operation of a cylinder (not shown in drawings).

In addition, a through hole 310 through which the driving shaft 210 of the motor 200 may pass may be formed in the back plate 300.

The motor 200 is disposed on the rear surface of the back plate 300. The motor 200 may be coupled and fixed to the rear surface of the back plate 300. The motor 200 includes the driving shaft 210 for outputting a rotational force, and the driving shaft 210 extends to a front surface of the back plate 300 through the through hole 310. The adjuster 100 is coupled to the driving shaft 210.

The adjuster 100 includes the first rod 121 coupled to the leading shoe 400 and the second rod 131 coupled to the trailing shoe 500. Linings 410 and 510 are coupled to outer surfaces of the leading shoe 400 and the trailing shoe 500, respectively, and come into contact with inner surfaces of drums (not shown) when expanding outward so as to perform a function of stopping the drum. In this case, pushing of the lining is carried out through the above-described wheel cylinder, and returning of the lining may be carried out by the shoe return spring.

The adjuster 100 may have any configuration which allows the first rod 121 and the second rod 131 to be linearly moved according to a rotational direction of the driving shaft 210 of the motor 200 in directions in which the first and second rods move away from the housing 110 or in directions in which the first and second rods approach the housing. That is, the configuration of the adjuster 100 in the present invention is not limited to one embodiment of the present invention.

In one embodiment of the present invention, when the parking brake is operated, the adjuster 100 is operated as described below. When the driving shaft 210 is rotated in one direction, the first rod 121 and the second rod 131 respectively coupled to the leading shoe 400 and the trailing shoe 500 are moved in an outward direction and push the leading shoe 400 and the trailing shoe 500 to allow the leading shoe and the trailing shoe to come into contact with the linings 410 and 510, respectively, so that the linings press the drum. When the driving shaft 210 is rotated to the other direction, the first rod 121 and the second rod 131 are moved in the directions in which the first and second rods approach each other (moved to original positions) to allow the leading shoe 400 and the trailing shoe 500 to be returned to original positions so that the parking brake is released.

The adjuster 100 may adjust a distance between the leading shoe 400 and the trailing shoe 500 according to the rotation of the driving shaft 210. In other words, in one embodiment of the present invention, the adjuster 100 may perform a function of adjusting a gap between the drum and each of the leading shoe 400 and the trailing shoe 500 in addition to a function of a parking brake.

Meanwhile, the leading shoe 400 and the trailing shoe 500 are provided with fastening holes 420 and 520 by which the first rod 121 and the second rod 131 may be fastened to the leading shoe and the trailing shoe, respectively.

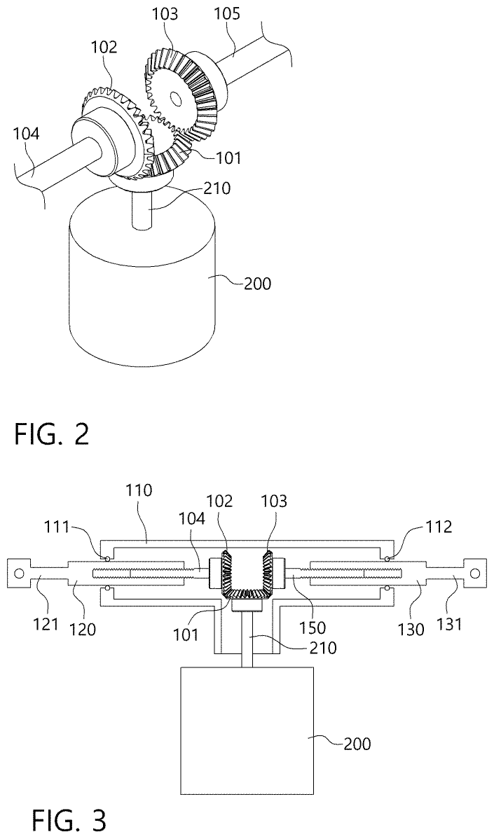

FIG. 2 is a perspective view showing a partial configuration of the adjuster of the drum-integrated type parking brake according to one embodiment of the present invention.

Referring to FIG. 2, the adjuster 100 is a driving system that may receive a driving force of the driving shaft 210 of the motor 200 to drive the first rod 121 and the second rod 131 and may include a driving bevel gear 101 coupled to the driving shaft 210, a pair of driven bevel gears 102 and 103 meshing with the driving bevel gear 101, and a pair of driven shafts 104 and 105 coupled to the pair of driven bevel gears 102 and 103, respectively.

The above-described configuration may be understood as one example in which the motor 200 is positioned on the rear surface of the back plate 300 and the driving force of the motor 200 is transmitted in a direction perpendicular to the driving shaft 210 for transmitting the driving force to the two driven shafts 104 and 105.

FIG. 3 is a cross-sectional view of the adjuster of the drum-integrated type parking brake according to one embodiment of the present invention.

Referring to FIG. 3, in one embodiment of the present invention, the adjuster 100 may include a T-shaped hollow housing 110, a driving bevel gear 101 provided in the housing 110 and configured to receive a driving force of the driving shaft 210 of the motor 200 to be rotated, a pair of driven bevel gears 102 and 103 meshing with the driving bevel gear 101, driven shafts 104 and 105 coupled to the pair of driven bevel gears 102 and 103, respectively, and extending in directions opposite to each other, nut parts 120 and 130 coupled with the driven shafts 104 and 105, respectively, to be moved in an axial direction when the driven shafts 104 and 105 are rotated, and the first rod 121 and the second rod 131 positioned outside the nut parts 120 and 130, respectively, to be coupled to the leading shoe 400 and the trailing shoe 500, respectively.

Below, configuration and operation of the adjuster 100 of the drum-integrated type parking brake according to one embodiment of the present invention will be described in more detail.

The driving-related configurations which are described above with reference to FIG. 2 may be included in the adjuster 100. More specifically, the driving bevel gear 101 coupled to the driving shaft 210 of the motor 200 to be rotated is located at a central portion, and the pair of driven bevel gears 102 and 103 mesh with the driving bevel gear 101 to transmit the driving force to the pair of driven shafts 104 and 105 disposed at both sides of the driving shaft 210 and disposed perpendicular to the driving shaft.

In one embodiment of the present invention, a thread (tap) is formed on an outer surface of each of the driven shafts 104 and 105, and the nut parts 120 and 130 are fastened to the driven shafts 104 and 105, respectively.

The nut parts 120 and 130 may be supported by bearings 111 and 112 provided in the housing 110 so as to be linearly moved in directions opposite to each other when the driven shafts 104 and 105 are rotated.

The first rod 121 and the second rod 131 are provided outside the nut parts 120 and 130 so as to be coupled to the leading shoe 400 and the trailing shoe 500, respectively.

In one embodiment of the present invention, when a driver selects a parking brake operation, a controller (not shown) of the vehicle drives the motor 200 to rotate the driving bevel gear 101 connected to the driving shaft 210, and a rotational force of the driving bevel gear 101 is transmitted to the pair of driven bevel gears 102 and 103.

As the two driven shafts 104 and 105 coupled to the driven bevel gears 102 and 103 are rotated in response to a rotation of the driven bevel gears 102 and 103, the nut parts 120 and 130 are linearly moved along the driven shafts 104 and 105 in directions in which the nut parts move away from the driving bevel gear 101.

Accordingly, a force is outwardly applied to the leading shoe 400 and the trailing shoe 500 coupled to the first rod 121 and the second rod 131 provided on the nut parts 120 and 130, respectively, to allow the leading shoe and the trailing shoe to come into contact with and press the drum, and thus the leading shoe and the trailing shoe act as a parking brake.

On the other hand, when the driver selects release of the parking brake, the motor 200 is rotated in a direction opposite to that in which the motor is driven when the parking brake is set, and as a result, the pair of driven shafts 104 and 105 are rotated in directions opposite to each other to allow the pair of nut parts 120 and 130 to be linearly moved in directions in which the nut parts approach each other.

Accordingly, the leading shoe 400 and the trailing shoe 500 are also returned to their original positions to release the parking brake.

As described above, the adjuster 100 of the present invention can perform a function of adjusting the gap between the drum and each of the leading shoe 400 and the trailing shoe 500 together with a function of the parking brake.

More specifically, the gap between the drum and each of the leading shoe 400 and the trailing shoe 500 or a rotating state of the motor 200 may be detected by a position sensor or a rotation number detecting sensor, and positions of the leading shoe 400 and the trailing shoe 500 may be adjusted such that wear of the linings 410 and 510 is canceled out.

That is, when the linings 410 and 510 are worn and the gap between the drum and each of the shoes is increased, by rotating the motor 200 with the proper number of revolutions, the nut parts 120 and 130 may be moved in the directions in which the nut parts move away from each other to push the leading shoe 400 and the trailing shoe 500 outward, and thus the gap between the drum and each of the shoes is adjusted.

The adjusted state as above may be reset as an initial position value, and control may be performed so that the gap is returned to the reset initial position upon release of the parking brake.

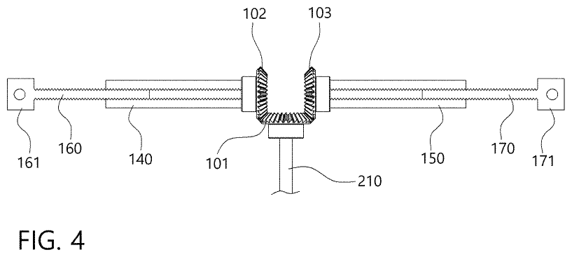

FIG. 4 is a cross-sectional view of an adjuster of a drum-integrated type parking brake according to another embodiment of the present invention.

Another embodiment of the present invention has the same function as that of the above-described embodiment of the present invention. However, a driving configuration of the adjuster 100 is replaced with cylindrical nut-type driven shafts 140 and 150 coupled to the driven bevel gears 102 and 103, respectively, and bolt parts 160 and 170 coupled to the nut-type driven shafts 140 and 150, respectively, to convert a rotation of each of the nut-type driven shafts 140 and 150 into a rectilinear motion. In this case, rods 161 and 171 coupled to the leading shoe 400 and the trailing shoe 500 may be positioned at ends of the bolts 160 and 170.

The drum-integrated type parking brake according to one embodiment of the present invention provides a parking brake structure capable of simultaneously driving both shoes through a structural modification of the adjuster.

In addition, the drum-integrated type parking brake according to one embodiment of the present invention does not employ a parking rod and a parking cable, and thus the configuration is simplified and assembly and maintenance are facilitated.

In addition, in the drum-integrated type parking brake according to one embodiment of the present invention, the motor employed for driving the adjuster is provided on the rear surface side of the back plate to prevent a substantial increase in an area.

Furthermore, the drum-integrated parking brake according to the embodiment of the present invention is configured to allow the adjuster to perform a shoe gap adjustment, which is an inherent function thereof, and a function of a parking brake, and thus the number of additional components is minimized to reduce manufacturing costs.

It will be apparent to those skilled in the art that the present invention is not limited to the above-described embodiments and may be variously modified and changed within a range which does not depart from the technical gist of the present invention.

What is claimed is:

1. A drum-integrated type parking brake comprising:
a motor disposed on a rear surface of a back plate and having a driving shaft passing through the back plate and extending to a front surface of the back plate;
an adjuster configured to convert a rotational force of the driving shaft into a linear reciprocating motion to linearly move a first rod and a second rod in directions which are opposite to each other; and
a leading shoe and a trailing shoe coupled to the first rod and the second rod of the adjuster, respectively, to press against or be spaced away from a drum.

2. The drum-integrated type parking brake of claim 1, wherein the adjuster is configured to linearly move the first rod and the second rod in a direction perpendicular to the driving shaft and in directions in which the rods move away from each other or in directions in which the rods approach each other.

3. The drum-integrated type parking brake of claim 2, wherein the adjuster comprises;
a driving bevel gear coupled to the driving shaft;
a pair of driven bevel gears configured to mesh with the driving bevel gear; and
a pair of driven shafts each coupled to one of the pair of driven bevel gears.

4. The drum-integrated type parking brake of claim 3, wherein each of the pair of driven shafts has a thread formed on an outer surface thereof,
the adjuster further comprises a pair of nut parts each coupled to one of the driven shafts to convert a rotation of the driven shafts into a rectilinear motion, and
each of the first rod and the second rod is positioned at one end of the nut parts.

5. The drum-integrated type parking brake of claim 3, wherein the pair of driven shafts are nut-type driven shafts,
the adjuster further comprises a pair of bolt parts each coupled to one of the nut-type driven shafts to convert a rotation of the nut-type driven shafts into a rectilinear motion, and
each of the first rod and the second rod is positioned at one end of the bolt parts.

6. The drum-integrated type parking brake of claim 1, further comprising a sensor provided to detect a gap between the drum and each of the leading shoe and the trailing shoe and to detect an adjusted position or the rotation number of the motor so that, after the motor is driven to adjust positions of the leading shoe and the trailing shoe to adjust the gap, the adjusted positions are set to initial values.
